(19) United States
(12) Patent Application Publication
(10) Pub. No.: US 2002/0156697 A1
(43) Pub. Date: Oct. 24, 2002

(54) Sales management device, seller device, customer device, medium having a program recorded therein, and sales management system

(75) Inventors: Koichi Okuhara, Nagano-ken (JP); Fumiaki Furihata, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/109,062

(22) Filed: Mar. 29, 2002

(30) Foreign Application Priority Data
Mar. 30, 2001 (JP) 2001-098807

(51) Int. Cl. G06F 17/60

(52) U.S. Cl. 705/26; 705/1

(57) ABSTRACT

A sales management device 20 is installed at the side of a manager (manufacturing company MC), who manages the sales of parts, and is connected via an intranet 11 to seller computers 31, 32, and 33, each of which is installed at the side of a selling company that sells the parts. This sales management device 20 is provided with a first data base part 23, which stores parts information, and a first control part 22, which transmits parts information to seller computers 31, 32, and 33, receives processed information resulting from the processing of parts information in accordance to dealers by seller computers 31, 32, and 33, and stores the processed information in first database part 23. By this sales management device 20, manufacturing company MC, which manages the sales of parts, can carry out unified management of the actual sales circumstances of the selling companies, and can thus readily grasp the levels of services provided by the sellers to the customers and consequently standardize the service level.

### BACKGROUND OF THE INVENTION

1. Field of the Invention

This invention relates to a sales management device, which is installed at the side of a manager who carries out management of the sales of goods, a seller device installed at the side of a seller who sells the goods, and a customer device installed at the side of a customer who purchases the goods from the seller. This invention also concerns a medium that has stored therein a program for making a computer function as the abovementioned sales management device, seller device, or customer device. This invention furthermore relates to a sales management system equipped with the abovementioned devices.

2. Description of the Prior Art

Priorly with regard to after-sales service parts to be provided after the sales of a product, after-sales service parts information were provided to selling companies from a sales management company, and then based on the after-sales service parts information, the selling companies processed information to a form suited to the selling companies' own customers as necessary and handed over the processed information to the customers. To be more specific, a system connected to enable communication between the server of the sales management company and the clients of the selling companies via a network was constructed, the client of each selling company downloaded the parts price list, which is the after-sales service parts information, from the server of the sales management company, and then after processing the after-sales service parts information, the selling company stored the processed information in a compact disk (CD) and handed over the CD to the customer or transmitted the processed information to the customer upon attaching the information to e-mail.

However, with the prior art, since each selling company processed the after-sales service parts information on its own, it was difficult for the sales management company to grasp what sort of support each selling company was providing to the customers. Large differences thus arose among the levels of support provided by the respective selling companies.

This invention has been made to resolve such a problem and a first object thereof is to provide a sales management device by which a manager can carry out unified management of the actual sales circumstances of the sellers. A second object of this invention is to provide a seller device by which goods information to be provided to customers can be prepared readily. Furthermore, a third object of this invention is to provide a customer device by which requested goods information can be obtained readily. A fourth object of this invention is to provide a sales management system that can achieve the above objects in a comprehensive manner.

### SUMMARY OF THE INVENTION

In order to achieve the above objects, a first aspect of this invention provides a sales management device, which is installed at the side of a manager who carries out management of the sales of goods, the sales management device comprising:

a goods information storage part for storing goods information;

a goods information transmitting part for transmitting the goods information stored in the abovementioned goods information storage part via a communication network to seller devices installed at the sides of sellers who sell the goods; and

a processed information receiving part for receiving processed information resulting from the processing of the abovementioned goods information by the abovementioned seller devices in accordance to customers who purchase the goods from the sellers via the abovementioned communication network from the abovementioned seller devices, and storing the processed information in the goods information storage part.

The sales management device of this invention transmits goods information stored in a goods information storage part to seller devices via a communication network. Thereafter, the goods information that have been processed according to customers at the seller devices, in other words, the processed information are received from the seller devices via the communication network and stored in the goods information storage part. Examples of the communication network used here include LAN, intranet, internet, etc., and examples of goods information include goods lists which list up the goods that can be transacted, and goods price lists which list up the prices of the respective goods. Since a manager, who manages the sales of goods, can carry out unified management of the actual sales circumstances of the sellers by this sales management device, the levels of services provided by the sellers to customers can be grasped readily and the service levels can consequently be standardized. Standardization of the support levels of the respective sellers can be achieved especially in the case where the goods are after-sales service parts.

The goods information transmitting part may transmit goods information to a seller device when a transmit command has been input from an input part (keyboard, mouse, etc.) of the sales management device or may transmit goods information to a seller device when a request for disclosure of goods information has been received from the seller device via the communication network. As an example of the former, a transmit command for transmitting goods information related to a new product to seller devices may be input prior to the start of sales of the new product and as an example of the latter, a request for disclosure of goods information concerning a product that is already sold commercially may be made when a seller is to handle the product anew.

With the sales management device of this invention, the abovementioned processed information may be information that has been processed using a tool provided from the side of the manager who manages the sales of goods. In this case, since the processed information in the respective seller devices will all have been prepared using the same tool, it will be easier for the manager to manage the processed information. Such a tool may be distributed by the manager to the respective sellers in the form of a tool stored in a CD-ROM or other storage medium or may be provided from the sales management device via the communication network. The latter case is convenient since upgrades, for example, can be accommodated for readily.

With the sales management device of this invention, the abovementioned goods information may be information that express the relationship between goods and purchase prices and the abovementioned tool may be an application software for calculating the sales prices of the respective goods based on the purchase prices upon deletion of unnecessary goods from and/or addition of necessary goods to the abovementioned goods information. In this case, information expressing the relationship between the goods and the purchase prices are provided as goods information from the sales management device to the seller devices, and by use of the above-described tool at each seller device, customization can be carried out readily since the deletion and addition of goods can be carried out as suited according to each seller's own form of transaction and the work burden is lightened since the sales prices can be calculated readily.

With the sales management device of this invention, the abovementioned goods information transmitting part may transmit goods information, which are relevant to a seller to whom the information are to be sent among the goods information stored in the abovementioned goods information storage part, to the abovementioned seller device via the abovementioned communication network. In this case, a seller can obtain goods information (which may contain processed information) that are relevant to him/herself without being troubled by unnecessary information that are not relevant to the seller him/herself. Goods information relevant to a seller to whom the information are to be sent refers to goods information, which suit the circumstances of the seller to whom the information are to be sent among the plurality of types of goods information prepared according to the circumstances of the respective sellers. For example, in the case where the sellers exist in a plurality of nations, the goods information relevant to a particular seller will be goods information, which are related to the currency of the nation to which the seller belongs among the plurality of types of goods information prepared according to the currencies of the respective nations.

The sales management device of this invention may be equipped with: a copied information storage part for storing copies of a part or all of the goods information stored in the abovementioned goods information storage part; a customer request receiving part for receiving requests for disclosure of the goods information from customer devices installed at the sides of the abovementioned customers via a communication network (shall be referred to hereinafter as “different communication network”) that differs from the abovementioned communication network; and a reply transmitting part for transmitting goods information which are relevant to the customer among the goods information stored in the abovementioned copied information storage part, to the abovementioned customer device via the abovementioned different communication network when an abovementioned request for disclosure is received by means of the abovementioned customer request receiving part. In this case, the goods information storage part is connected to the respective seller devices via a communication network (for example, an intranet) and the copied information storage part is connected to the respective customer devices via a different communication network (for example, the internet). Since sellers are generally placed under the management of the manager in many cases, it is infrequent that suspicious access will be made from a seller device and there is little danger that the contents stored in the goods information storage part of sales management device will be destroyed when a seller device becomes connected to the goods information storage device. On the other hand, since a customer will in many cases fall outside the scope of management of the manager, there is a possibility that suspicious access will made from a customer device, and the respective customer devices are thus arranged to be connected not to the goods information storage part of the sales management device but to the copied information storage device, into which part or all of the contents of the good information storage part have been copied, so that even when for instance the copied contents are destroyed by a customer, the stored contents of the goods information storage part will be saved.

Product information relevant to a customer refers to information concerning the goods that the customer is about to purchase, information concerning the goods that the customer is handling, etc. For example, in the case where a single seller has a plurality of customers and changes the goods information according to each customer, the abovementioned goods information relevant to a customer will be goods information for a particular customer among the plurality of customers. Also, only those information that need to be disclosed to customers among the information stored in the goods information storage part may be copied in the copied information storage part. For example, while detailed specifications of goods may be disclosed to sellers, just the principal specifications among the detailed specifications may be disclosed to the customers.

Here, it is preferable that access from the abovementioned customer devices to the abovementioned copied information storage part be permitted and that access from the abovementioned customer devices to the abovementioned goods information storage part be prohibited. In this case, the danger of destruction of the data in the goods information storage part can be avoided more definitely. Such an arrangement may also be realized for example by employment of a known firewall.

A program for making a computer function as the above-described sales management device is normally recorded in a CD-ROM, HDD, or other storage medium that can be read by the CPU of the computer and is read from the storage medium and executed by the CPU. Such a program is thus used to exhibit the actions and effects of the sales management device described above and is high in usefulness.

A second aspect of this invention provides a seller device installed at the side of a seller who sells goods, the seller device comprising:

a goods information receiving part for receiving goods information from a sales management device installed at the side of a manager who manages the sales of the goods via a communication network;

a goods information processing part for processing the goods information received from the abovementioned goods information receiving part in accordance to customers who purchase the goods from the seller; and

a processed information transmitting part for transmitting the processed information processed by the abovementioned goods information processing part to the abovementioned sales management device via the communication network.

The seller device of this invention processes the goods information, received from a sales management device and via a communication network, into processed information in accordance to customers and transmits the processed information via the communication network to the sales management device. Examples of the communication network used here include LAN, intranet, internet, etc., and examples of goods information include goods lists which list up the goods that can be transacted, and goods price lists which list up the prices of the respective goods. With this seller device, since a seller receives goods information that are to serve as core information from the manager and since these information can be used and processed according to each seller's own customers into goods information for the respective customers, goods information for each customer can be prepared readily.

With the seller device of this invention, the abovementioned goods information processing part may process the information using a tool provided from the side of the manager who manages the sales of the goods. In this case, the seller does not have to develop a unique tool. Such a tool may be provided from the manager in the form of a tool stored in a CD-ROM or other storage medium or may be provided from the sales management device via the communication network. The latter case is convenient since upgrades, for example, can be accommodated for readily.

With the seller device of this invention, the abovementioned goods information may be information that express the relationship between goods and purchase prices and the abovementioned tool may be an application software for calculating the sales prices of the respective goods based on the purchase prices upon deletion of unnecessary goods from and addition of necessary goods to the abovementioned goods information. In this case, information expressing the relationship between the goods and the purchase prices are received as goods information by the seller device, and by use of the above-described tool at the seller device, customization can be carried out readily since the deletion and addition of goods can be carried out as suited according to each seller's own form of transaction and the work burden is lightened since the sales prices can be calculated readily.

A program for making a computer function as the above-described seller device is normally recorded in a CD-ROM, HDD, or other storage medium that can be read by the CPU of the computer and is read from the storage medium and executed by the CPU. Such a program is thus used to exhibit the actions and effects of the seller device described above and is high in usefulness.

A third aspect of this invention provides a customer device installed at the side of a customer who purchases goods from a seller, the customer device comprising:

a customer request transmitting part for transmitting requests for disclosure of goods information to a sales management device installed at the side of a manager who manages the sales of the goods via a communication network; and

a reply receiving part for receiving the goods information relevant to the customer as the reply to the abovementioned request for disclosure from the abovementioned sales management device via the abovementioned communication network.

This invention's customer device is convenient since when a customer wants to obtain goods information and transmits a request for disclosure of the information, the goods information relevant to the customer him/herself is returned. Examples of the communication network used here include LAN, intranet, internet, etc., and examples of goods information include goods lists which list up the goods that can be transacted, and goods price lists which list up the prices of the respective goods. However, this communication network is preferably a communication network that differs from the communication network that connects the seller devices with the sales management device.

A program for making a computer function as the above-described customer device is normally recorded in a CD-ROM, HDD, or other storage medium that can be read by the CPU of the computer and is read from the storage medium and executed by the CPU. Such a program is thus used to exhibit the actions and effects of the customer device described above and is high in usefulness.

A fourth aspect of this invention provides a sales management system comprising the above-described sales management system and the above-described seller devices. This sales management system is high in usefulness as it is a system that exhibits the actions and effects of the above-described sales management device and seller devices. This sales management system may also comprise the above-described customer devices and its usefulness is made even higher in this case.

### BRIEF DESCRIPTION OF THE DRAWINGS

FIG. 1 is a block diagram, which shows an outline of the arrangement of a sales management system of an embodiment,

FIG. 2 is a table, which shows the stored contents of a first database part of a first server,

FIG. 3 is an explanatory diagram of a parts price list and parts list for a block A1 of a product model A,

FIG. 4 is a flowchart of the parts price list transmitting process of the first server,

FIG. 5 is a flowchart of the list intake and processing process of a seller computer,

FIG. 6 is a flowchart of the data transmitting process of the first server,

FIG. 7 is a flowchart of the customer request process of a customer computer,

FIG. 8 is a flowchart of the processed list preparation routine of the seller computer,

FIG. 9 shows an item entry screen that is displayed in the process of preparing a processed list,

FIG. 10 shows the calculation method setting screen that is displayed in the process of preparing the processed list, and

FIG. 11 is an explanatory diagram, which illustrates the manner in which the processed list is prepared.

### DESCRIPTION OF THE PREFERRED EMBODIMENTS

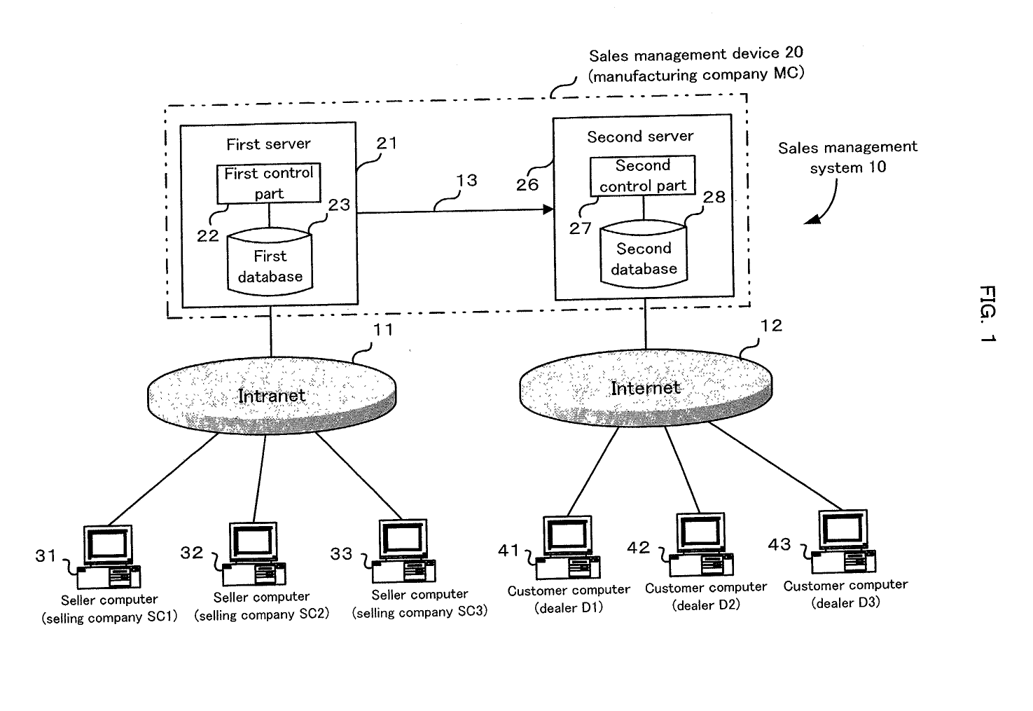

Preferred embodiments of this invention shall now be described based on the drawings. FIG. 1 is a block diagram, which shows an outline of the arrangement of a sales management system of an embodiment by which this invention is realized. This sales management system 10 is comprised of a sales management device 20, which is installed at the side of a manager who manages the sales of parts, seller computers 31, 32, and 33, which are installed at the sides of sellers who sell the parts, and customer computers 41, 42, and 43, which are installed at the sides of customers who purchase the parts from the sellers. With the present embodiment, the manager is also the manufacturer of the parts and shall be referred to as manufacturing company MC. Also, there exist three sellers, who shall be referred to respectively as selling companies SC1, SC2, and SC3. Furthermore, there exist three customers who shall be referred to respectively as dealers D1, D2, and D3.

Sales management device 20 is comprised of a first server 21, which can perform bidirectional communication with seller computers 31, 32, and 33 via an intranet 11, and a second server 26, which can perform bidirectional communication with customer computers 41, 42, and 43 via internet 12. With this sales management system 10, parts price lists, which express the association of the parts and the prices, are provided from sales management device 20 to seller computers 31, 32, and 33 and customer computers 41, 42, and 43. Also with the present embodiment, an identification code (seller ID) is provided in advance to each selling company and an identification code (customer ID) is provided in advance to each dealer.

First server 21 is equipped with a first control part 22, which is mainly comprised of a known form of CPU, ROM, RAM, keyboard, mouse, intranet extension board, etc., and a first database part 23, in which the parts price lists are arranged and stored in the form of a database. In response to an input instruction from a keyboard or mouse or in response to a list disclosure request from seller computer 31, 32, or 33, first control part 21 searches the parts price lists stored in first database part 23 and transmits the search results to seller computer 31, 32, or 33. Also, first control part 22 receives parts price lists (processed lists) that have been processed by seller computer 31, 32, and 33 and arranges the processed lists in the form of a database in first database 23 upon associating the processed lists with the predetermined seller ID's and customer ID's in order to make clear the relationship between the seller that sent each processed list and the customers to whom each processed list applies. Furthermore, first control part 22 transmits, at a suitable timing, parts of the parts price lists stored in first database 23 as lists for customers to second server 26 via communication line 13.

Second server 26 is equipped with a second control part 27, which is mainly comprised of a known form of CPU, ROM, RAM, keyboard, mouse, modem, etc., and a second database part 28, in which a list for customers that has been sent from first server 21 is arranged and stored in the form of a database. In response to an input instruction from a keyboard or mouse or in response to a price disclosure request from customer computer 41, 42, or 43, second control part 27 searches the customer list stored in second database part 28 and transmits the search results to customer computer 41, 42, or 43.

Seller computers 31, 32, and 33 are known, general-purpose computers, each comprised of a display and a main unit device (device equipped with a CPU, ROM, RAM, clock, HDD, intranet extension board, etc.), that are installed at selling companies SC1, SC2, SC3, respectively, and a list processing tool, provided by manufacturing company MC, is installed along with a browser software in the HDD's. As this list processing tool, a list processing tool that has been downloaded via intranet 11 from first server 21 of sales management device 20 may be installed or a CD-ROM or other recording medium in which the list processing tool is stored may be received from manufacturing company MC and this stored tool maybe installed. Each of seller computers 31, 32, and 33 receives a parts price list from first server 21 via intranet 11, uses the list processing tool to delete unnecessary parts from or add necessary parts to the parts price list and calculate the sales prices of the respective parts based on the purchasing parts to prepare a processed list, attaches the applicable customer ID's to the processed list, and transmits the processed list via intranet 11 to first server 21.

Customer computers 41, 42, and 43 are known, general-purpose computers, each comprised of a display and a main unit device (device equipped with a CPU, ROM, RAM, clock, HDD, modem, etc.), that are installed at dealers D1, D2, D3, respectively, and a browser software, etc., are installed in the HDD's. Each of the customer computers 41, 42, and 43 enable the parts, for which the prices are to be made known, to be selected from a browser screen and the parts that have been selected here are sent as a customer request via internet 12 to second server 26. Also, customer computers 41, 42, and 43 receive replies from second server 26 via internet 12.

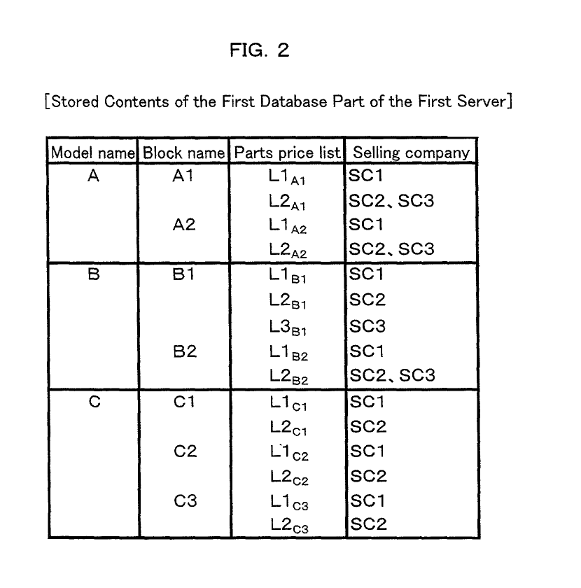

An example of use of sales management system 10 of the present embodiment shall now be described. A table, such as shown in FIG. 2, is stored in first database part 23 of first server 21 of sales management device 20. This table shall now be described. That is, manufacturing company MC manufactures printers of models A to C, and of these, model A is comprised of a plurality of blocks (part blocks) A1 and A2 and each of blocks A1 and A2 is comprised of a plurality of parts. There are two parts price lists for block A1 and the list ID's of the respective parts price lists are L1_{A1} and L2^{A1}. There are also two parts price lists for block A2 and the list ID's of the respective parts price lists are L1_{A2} and L2_{A2}. A plurality of parts price lists exist for a single block since manufacturing company MC changes the price setting according to the transacting party. Here, for selling company SC1, the parts price list L1_{A1} is employed for block A1 and the parts price list L1_{A2} is employed for block A2. For selling companies SC2 and SC3, the parts price list L2_{A1} is employed for block A1 and the parts price list L2_{A2} is employed for block A2. As shown in the table of FIG. 2, which parts price list is employed for which company is determined likewise for each of the blocks of models B and C as well. First server 21 determines which parts price list to transmit to which selling company by searching this table.

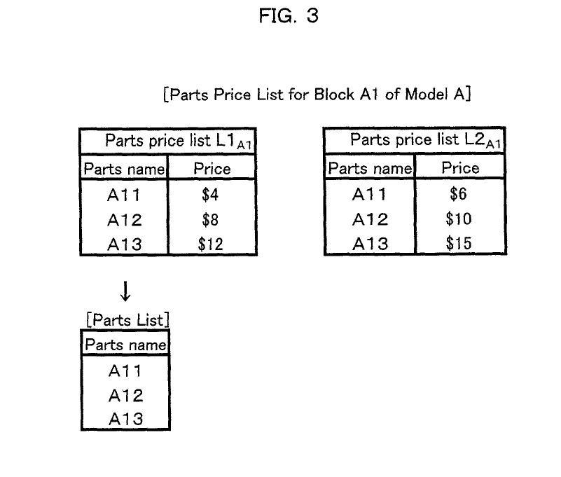

As is clear from the table of FIG. 2, whereas selling companies SC1 and SC2 handle models A to C, selling company SC3 handles just the models A and B and does not handle the model C. Examples of the parts price lists for block A1 of model A are shown in FIG. 3 and such price lists are also stored in first database part 23 of first server 21. That is, block A1 is comprised of parts of parts names A11, A12, and A13, and prices are set according to each part. Though in FIG. 3, both parts price lists are expressed in US dollars, one price list may for example be expressed in US dollars and this may be made applicable to a selling company in the United States of America and the other price list may be expressed in Deutsche marks and made applicable to a selling company in Germany.

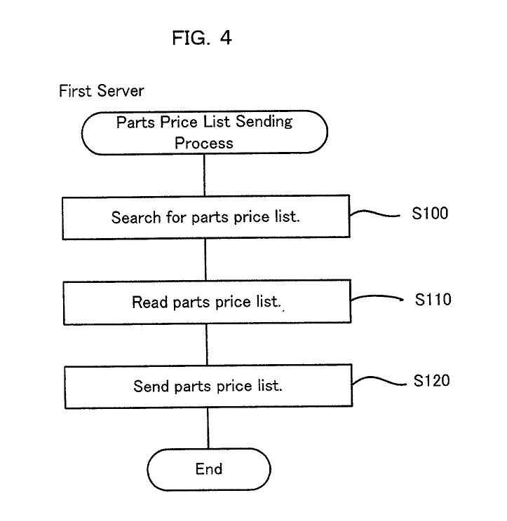

When an instruction for transmitting a particular parts price list is made from an unillustrated keyboard or mouse, first server 21 reads and executes a parts price list transmitting program (see FIG. 4). First, the parts price list for which the transmit instruction has been made is searched from first database part 23 (step (referred to hereinafter as “S”) 100), the search result, in other words, the parts price list for which the transmit instruction has been made is read (S110), this parts price list is sent via intranet 11 to the seller computer of the selling company corresponding to the parts price list (S120), and this program is ended. This parts price list transmitting program is likewise executed when a list disclosure request has been made via intranet 11 from seller computer 31, 32, or 33.

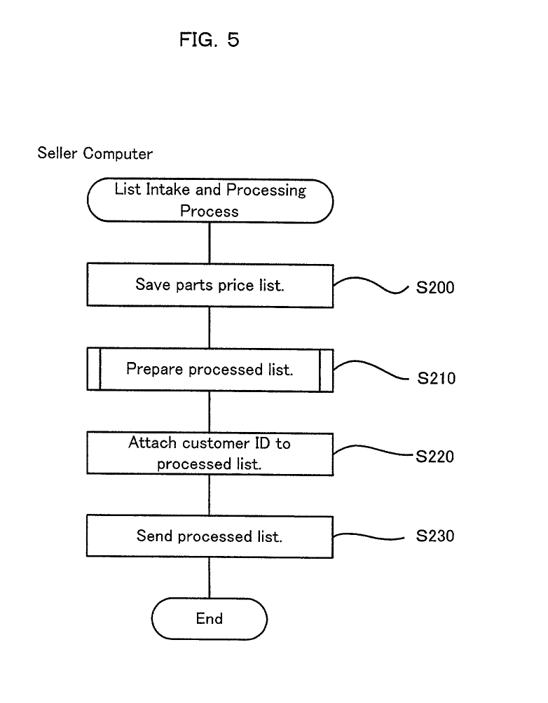

Upon receiving a parts price list via intranet 11 from first server 21, seller computer 31, 32, or 33 reads and executes the list intake and processing program (see FIG. 5). First, the received parts price list is saved in an HDD (S200) and then the list processing tool is started up and by processing the parts price list as a core, the processed list for each customer is prepared (S210). This point shall be described in further detail later. The customer ID applicable to the processed list is then attached (S220) and the processed list is transmitted to first server 12 via intranet 11 (S230). Though for the sake of convenience of description, it has been described here that the processed list is prepared immediately after the parts price list has been saved, the parts price list may be read and the processed list be prepared when it has become necessary after the saving of the parts price list.

Upon receiving the processed list with customer ID attached via intranet 11, first server 21 of sales management device 20 stores the contents of the processed list, the seller ID of the selling company that prepared the processed list, and the customer ID attached to the processed list in an associated form in first database part 23.

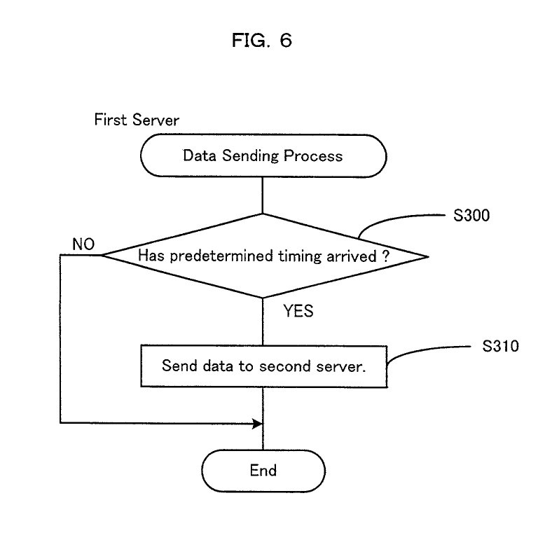

Also, first server 21 reads and executes a data transmitting program (see FIG. 6) every few ms. When this data transmitting program is started, it is first judged whether or not a predetermined timing (for example, a periodic timing, a timing instructed from a keyboard or mouse, the timing at which the processed list was received from a seller computer, etc.) has arrived (S300) and if the predetermined timing has not arrived, this program is ended. On the other hand, if the predetermined timing has arrived, the contents stored in first database part 23 are transmitted via communication line 13 to second server 26 (S310) and this process is ended. At S310, the contents, which have already been sent among the contents stored in first database part 23, are not sent, and only the parts of the processed list that are necessary for a customer is sent as a customer list along with the seller ID of the selling company that prepared the list and the customer ID of the dealer to which the list applies.

Upon receiving the customer list from first server 21, second server 22 of sales management device 20 stores the contents of the customer list, the seller ID of the selling company that prepared the list, and the customer ID of the dealer to which the list applies in an associated form in second database part 28.

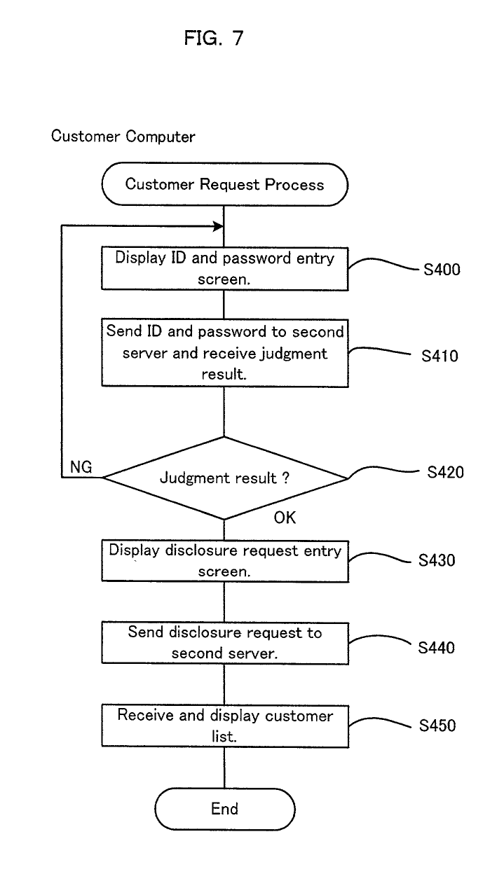

When dealer D1 (the same applies to dealers D2 and D3) wants to know the price of the parts of a printer of a certain model, dealer D1 starts up a browser software at customer computer 41 and connects to second server 26 of sales management device 20 via internet 12. Customer computer 41 then reads and executes a customer request processing program (see FIG. 7). When this program is started, first a customer ID and password entry screen is displayed on the display (S400). It shall be deemed that dealer D1 has been registered in advance as a legitimate customer in second server 22 via internet 12 and that the customer ID and the password have been set in this process. When the customer ID and password have been entered at the entry screen, customer computer 41 transmits these to second server 26 via internet 12, it is judged at second server 26 whether or not dealer D1 is a legitimate customer based on the customer ID and the password, and customer computer 41 receives the judgment result via internet 12 (S410). Customer computer 41 then checks the judgment result (S420) and if the judgment result is NG, that is, if dealer D1 has been judged not to be a legitimate customer, are turn to step S400 is performed while if the judgment result is OK, that is, if dealer D1 has been judged to be a legitimate customer, a disclosure request entry screen is displayed on the display (S430). Next upon entry of the model name and parts names at the disclosure request entry screen, customer computer 41 transmits these to second server 26 via internet 12 (S440). Second server 26, which has received the model name and parts names, searches second database part 28 based on the customer ID, model name, and parts names, reads out the applicable customer list, and transmits this list to customer computer 41 via internet 12. Customer computer 41 then receives the customer list and displays it on the display (S450). Dealer D1 can thus know the parts prices he/she wanted to know.

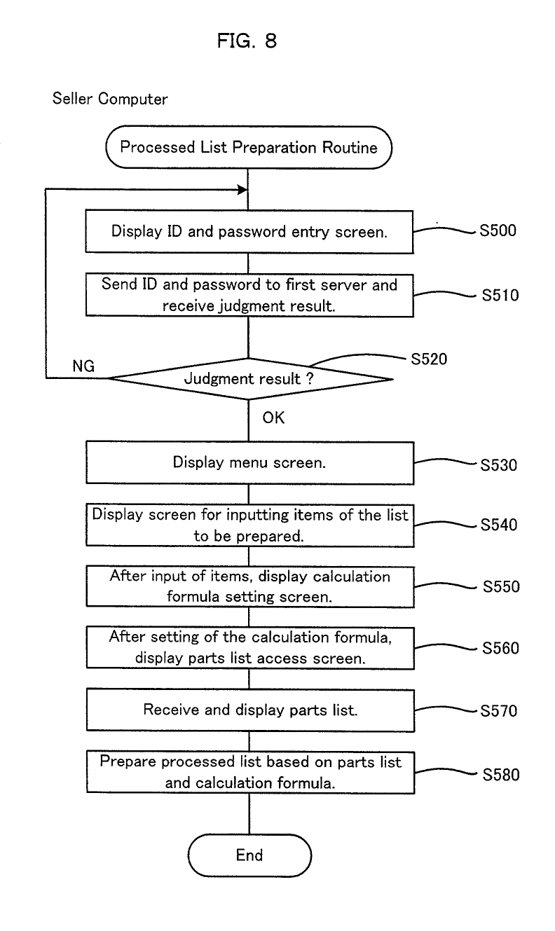

The processed list preparation routine (see FIG. 8) that is executed at seller computer 31 shall now be described in further detail (the same processes are also executed at seller computers 32 and 33). When the list processing tool program is started, seller computer 31 displays the seller ID and password entry screen on the display (S500). It shall be deemed that selling company SC1 has been registered in advance as a legitimate seller in first server 21 via intranet 11 and that the seller ID and password have been set in this process. When the seller ID and password have been entered at the entry screen of S300, seller computer 31 transmits these to first server 21 via intranet 11, it is judged at first server 21 whether or not selling company SC1 is a legitimate customer based on the seller ID and the password, and seller computer 31 receives the judgment result via intranet 11 (S510). Seller computer 31 then checks the judgment result (S520) and if the judgment result is NG, that is, if selling company SC1 has been judged not to be a legitimate seller, a return to step S500 is performed while if the judgment result is OK, that is, if selling company SC1 has been judged to be a legitimate seller, the menu screen of the list processing tool is displayed on the display (S530).

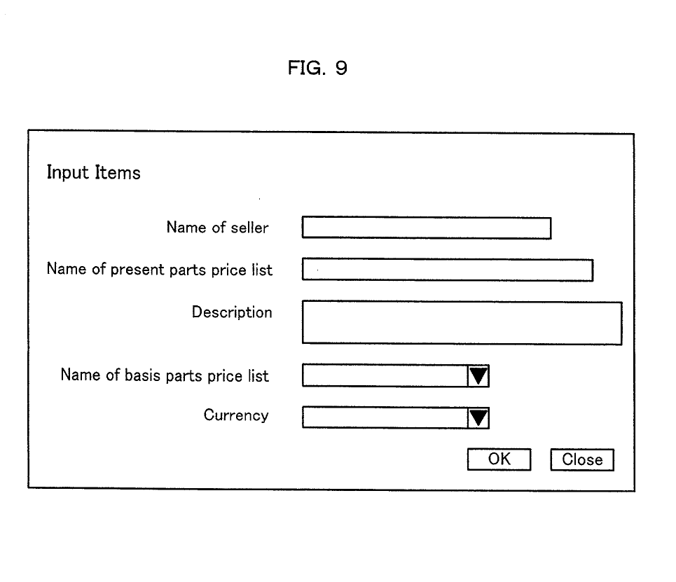

Then when the price maintenance item is selected at the menu screen, seller computer 31 displays, on the display, the item entry screen for entering the name of the seller, the name of the present parts price list to be prepared and the description thereof, the name of the parts price list to serve as the basis, the currency of the present parts price list to be prepared, etc. (S540, see FIG. 9). Here, since it is already clear from the seller ID that the seller name is selling company SC1, the seller name is displayed in a priorly entered condition. Also, as the name of the parts price list to be prepared now, a name that will serve as a unique ID or name for this parts price list is entered. Furthermore, the name of the basis parts price list can be entered by selection from a pull-down menu, and in this pull-down menu are listed the parts price lists, which, among the tables shown in FIG. 2, are applicable to selling company SC1. Here, the prices in the parts price lists applicable to selling company SC1 are the purchase prices for selling company SC1.

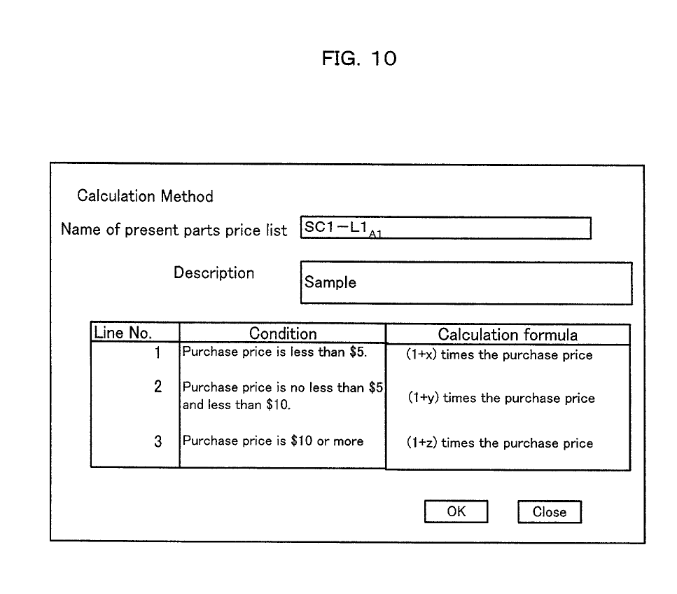

When the entry of the respective items of the above-described entry screen has been completed, seller computer 31 displays, on the display, a screen for setting the price calculation method for the present parts price list to be prepared (S550, see FIG. 10). An operator of selling company SC1 sets, on this screen, how the sales prices for selling to customers are to be set based on the prices listed in the basis parts price list, in other words, the purchase prices. For example, the sales prices are set according to the range of the purchase prices or the sales prices are set according to the stock items. As an example of the former, the sales prices are set in the manner of “when the purchase price is less than $5, the sales price is (1+x) times the purchase price,” “when the purchase price is $5 or more and less than $10, the sales price is (1+y) times the purchase price,” and “when the purchase price is $10 or more, the sales price is (1+z) times the purchase price” as shown in FIG. 10. In the latter case, though unillustrated, the sales prices are set for example in the manner of “if the stock item is a head or an ink cartridge, the sales price is (1+w) times the purchase price” and “if the stock item is anything else, the sales price is (1+v) times the purchase price.” How the digits below the decimal point are to be handled can also be set here.

After the setting of the calculation method, seller computer 31 displays the parts list access screen on the display (S560). When the model name and block name have been entered in this parts list access screen, seller computer 31 transmits the entered names to first server 21 via intranet 11. First server 21 then searches first database part 23 using the model name, block name, and seller name as search formulae, determines the applicable parts price list, and transmits back, as a parts list, a list in which the prices have been deleted from the applicable parts price list to seller computer 31 via intranet 11. Seller computer 31 then receives this parts list and displays it on the display (S570). For example when an operator enters model A and block A1 in the parts list access screen, first server 21 performs collation with the table of FIG. 2 and determines parts price list L1_{A1}, transmits the parts list (see FIG. 2), in which the prices have been deleted from parts price list L1_{A1}, as a reply to seller computer 31, and seller computer 31 receives this parts list and displays it on the display. The operator then checks from this screen whether or not the parts to be handled by selling company SC1 are shown without any excess or deficiency and, if there is an excess or deficiency, performs the deletion of parts or addition of parts.

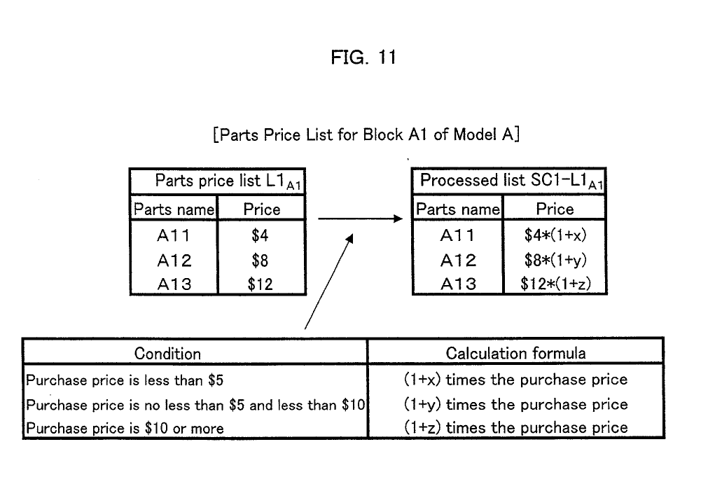

After completion of confirmation of the parts list, seller computer 31 calculates the sales prices by applying the calculation method set at S550 to the basis parts price list and displays, on the display, the parts price list, in which these sales prices are incorporated, as the present parts price list (S580). For example, when as shown in FIG. 11, the basis parts price list is parts price list L1_{A1}, the above mentioned calculation method is applied to this list so that the present parts price list SC1-L1_{A1} will be displayed. This is the processed list preparation routine.

The correspondence between the present embodiment and the components of this invention shall now be described. First server 21 and first database part 23 of sales management device 20 of the present embodiment correspond to the goods information storage part of the sales management device of this invention and first control part 22 corresponds to the goods information transmitting part and processed information receiving part. Second database part 28 of second server 26 corresponds to the copied information storage part, and second control part 27 corresponds to the customer request receiving part and the reply transmitting part. Each of the CPU's of seller computers 31, 32, and 33 corresponds to the goods information receiving part, goods information processing part, and processed information transmitting part of the seller device. Furthermore, each of the CPU's of customer computers 41, 42, and 43 corresponds to the customer request transmitting part and the reply receiving part.

By the embodiment described in detail above, since manufacturing company MC, which manages the sales of parts, can carry out unified management of the actual sales circumstances of the respective selling companies SC1, SC2, and SC3, it can readily grasp the levels of service provided by the respective selling companies SC1, SC2, and SC3 to the dealers and can consequently standardize the level of service. The level of support provided by the respective selling companies SC1, SC2, and SC3 can be standardized especially in the case where the goods are after-sales service parts.

Also, since the processed list is processed using the list processing tool provided from manufacturing company MC, it can be controlled readily by manufacturing company MC. Since deletion or addition of parts can be carried out suitably according to one's form of transaction by using this list processing tool, customization can be carried out readily, and the work burden will be light since the sales prices can be calculated readily.

Furthermore, each of the respective selling companies SC1, SC2, and SC3 can obtain parts price lists that are relevant to oneself without being troubled by unnecessary parts price lists that are not relevant to oneself. That is, as shown in the table of FIG. 2, for block A1 of model A, parts price list L2^{A1} is not sent to selling company SC1 but parts price list L1_{A1} is sent to selling company SC1.

Furthermore, since dealers D1, D2, and D3 are in many cases beyond the scope of management of manufacturing company MC, there is a possibility that suspicious access will be made from a customer computer 41, 42, or 43. Thus for customer computers 41, 42, and 43, connection is made not to first database part 23 of first server 21 but to second database part 28, into which part or all of the contents of first database part 23 have been copied, so that even when the copied contents of second database part 28 are destroyed by a customer, the stored contents of first database 23 will be maintained.

Also since each of selling companies SC1, SC2, and SC3 receives a parts price list that serves as a core from manufacturing company MC and uses this parts price list to perform processing according to the selling company's own customers to prepare a processed list, a processed list can be prepared readily according to each customer. Convenience is also provided since the prices of parts that a dealer D1, D2, or D3 wants to obtain are indicated when the dealer makes a request via internet 12 to second server 26 for the prices.

Furthermore, a program for making a computer function as the above-described first server 21 or second server 26, a program for making a computer function as the above-described seller computer 31, 32, or 33, and a program for making a computer function as the above-described customer computer 41, 42, or 43 are used to exhibit the above-described actions and effects and are thus high in usefulness.

Embodiments of this invention are by no means limited to the embodiment described above and it is needless to say that various forms may be taken within the technical scope of this invention. For example, in the case where selling company SC1 wants to set a plurality of prices for the same parts (for example, in the case where dealer D1 and dealer D2 are one's customers and one wants to differ the prices according to dealer), the “Name of present parts price list” in FIG. 9 can be set to different names for processing.

Also, in the case where the selling company that is to prepare the processed list presently is a primary seller (a party that sells upon stocking from manufacturing company MC), since the prices listed in the parts price list of manufacturing company MC will be the purchase prices, the parts price list of manufacturing company MC will be the basis parts price list. On the other hand, in the case where the selling company that is to prepare the processed list presently is a secondary seller (a party that sells upon stocking from a primary seller), since the prices listed in the parts price list of the primary seller will be the purchase prices, the parts price list of the primary seller will be the basis parts price list. The basis parts price list is determined in likewise manner for the tertiary seller onwards.

Furthermore, not only the names of parts, but the quantities used in a block, the drawing reference Nos., etc., may also be listed in a parts list. The drawing reference Nos. may be arranged so that when a No. is clicked, the entire drawing of the block will be displayed along with a symbol and the drawing reference No. may be made correspond to the displayed symbol.

Furthermore, in the case where the contents of a description attached to a parts price list (see FIG. 9) are of low relevance to each dealer, the contents may be omitted.

Also, first server 21 may be arranged to enable access from intranet 11 and prohibit access from internet 12. Such an arrangement may be realized for example by the employment of a known firewall. Since suspicious access to first server 21 from customer computers 41, 42, and 43, which cannot be placed readily under the management of manufacturing company MC, can thus be avoided, the stored contents of first database part 23 will be protected securely.

What is claimed is:

1. A sales management device installed at the side of a manager who carries out management of the sales of goods, said sales management device comprising:
a goods information storage part for storing goods information;
a goods information transmitting part for transmitting the goods information stored in said goods information storage part via a communication network to seller devices installed at the sides of sellers who sell the goods; and
a processed information receiving part for receiving processed information resulting from the processing of said goods information by said seller devices in accordance to customers who purchase the goods from the sellers via said communication from said seller devices and storing said processed information in said goods information storage part.

2. A sales management device in accordance with claim 1, said sales management furthermore comprising:
an input part for inputting a transmit command, wherein
said goods information transmitting part transmits said goods information to an abovementioned seller device when said transmit command is input from said input part.

3. A sales management device in accordance with claim 1, wherein
said goods information transmitting part transmits said goods information to an abovementioned seller device when a request for disclosure of said goods information is received via said communication network from said seller device.

4. A sales management device in accordance with claim 1, wherein
said processed information are processed using a tool provided from the side of the manager who manages the sales of goods.

5. A sales management device in accordance with claim 4, wherein
said goods information are information that express the relationship between goods and purchase prices; and said tool is an application software for calculating the sales prices of the respective goods based on the purchase prices upon deletion of unnecessary goods from and/or addition of necessary goods to said goods information.

6. A sales management device in accordance with claim 1, wherein
said goods information transmitting part transmits goods information which are relevant to the seller to whom the information are to be sent among the goods information stored in said goods information storage part.

7. A sales management device in accordance with claim 1, said sales management device furthermore comprising:
a copied information storage part for storing copies of a part or all of the goods information stored in said goods information storage part;
a customer request receiving part for receiving requests for disclosure of the goods information from customer devices installed at the sides of said customers via a communication network (shall be referred to hereinafter as “different communication network”) that differs from said communication network; and
a reply transmitting part for transmitting goods information, which are relevant to the customer among the goods information stored in said copied information storage part, to said customer device via said different communication network when an abovementioned request for disclosure is received by means of said customer request receiving part.

8. A sales management device in accordance with claim 7, wherein
access from said customer devices to said copied information storage part is permitted and access from said customer devices to said goods information storage part is prohibited.

9. A storage medium, which can be read by a computer and has stored therein a program for making a computer function as a management device, said storage medium comprising:
a goods information storage part for storing goods information;
a goods information transmitting part for transmitting the goods information stored in said goods information storage part via a communication network to seller devices installed at the sides of sellers who sell the goods; and
a processed information receiving part for receiving processed information resulting from the processing of said goods information by said seller devices in accordance to customers who purchase the goods from the sellers via said communication network from said seller devices and storing said processed information in said goods information storage part.

10. A storage medium, which can be read by a computer and has stored therein a program for making a computer function as a management device, said storage medium comprising:
a goods information storage part for storing goods information;
a goods information transmitting part for transmitting the goods information stored in said goods information storage part via a communication network to seller devices installed at the sides of sellers who sell the goods;
a processed information receiving part for receiving processed information resulting from the processing of said goods information by said seller devices in accordance to customers who purchase the goods from the sellers via said communication network from said seller devices and storing said processed information in said goods information storage part;
a copied information storage part for storing copies of a part or all of the goods information stored in said goods information storage part;
a customer request receiving part for receiving requests for disclosure of the goods information from customer devices installed at the sides of said customers via a communication network (shall be referred to hereinafter as “different communication network”) that differs from said communication network; and
a reply transmitting part for transmitting goods information, which are relevant to the customer among the goods information stored in said copied information storage part, to said customer device via said different communication network when an abovementioned request for disclosure is received by means of said customer request receiving part,.

11. A seller device, which is installed at the side of a seller who sells goods, said seller device comprising:
a goods information receiving part for receiving goods information from a sales management device installed at the side of a manager who manages the sales of the goods via a communication network;
a goods information processing part for processing the goods information received by said goods information receiving part in accordance to customers who purchase the goods from the seller; and
a processed information transmitting part for transmitting the processed information processed by said goods information processing part to said sales management device via the communication network.

12. A seller device in accordance with claim 11, wherein said goods information processing part processes the goods information using a tool provided from the side of the manager who manages the sales of the goods.

13. A seller device in accordance with claim 12, wherein
said goods information are information that express the relationship between goods and purchase prices; and said tool is an application software for calculating the sales prices of the respective goods based on the purchase prices upon deletion of unnecessary goods from and addition of necessary goods to said goods information.

14. A storage medium, which can be read by a computer and has stored therein a program for making a computer function as a seller management device, said storage medium comprising:
a goods information receiving part for receiving goods information from a sales management device installed at the side of a manager who manages the sales of the goods via a communication network;
a goods information processing part for processing the goods information received by said goods information receiving part in accordance to customers who purchase the goods from the seller; and
a processed information transmitting part for transmitting the processed information processed by said goods information processing part to said sales management device via the communication network.

15. A customer device, which is installed at the side of a customer who purchases goods from a seller, comprising:
a customer request transmitting part for transmitting requests for disclosure of goods information via a communication network to a sales management device installed at the side of a manager who manages the sales of the goods; and
a reply receiving part for receiving the goods information relevant to the customer as the reply to an abovementioned request for disclosure from said sales management device via said communication network.

16. A storage medium, which can be read by a computer and has stored therein a program for making a computer function as a customer device, said storage medium comprising:
a customer request transmitting part for transmitting requests for disclosure of goods information via a communication network to a sales management device installed at the side of a manager who manages the sales of the goods; and
a reply receiving part for receiving the goods information relevant to the customer as the reply to an abovementioned request for disclosure from said sales management device via said communication network.

17. A sales management system including a sales management device installed at the side of a manager who manages the sales of goods and seller devices installed at the sides of sellers who sell the goods, and wherein
said sales management device comprising:
a goods information storage part for storing goods information;
a goods information transmitting part for transmitting the goods information stored in said goods information storage part via a communication network to the seller devices installed at the sides of the sellers who sell the goods; and
a processed information receiving part for receiving processed information resulting from the processing of said goods information by said seller devices in accordance to customers who purchase the goods from the sellers via said communication network from said seller devices and storing said processed information in said goods information storage part, and
each of said seller devices comprising:
a goods information receiving part for receiving goods information from the sales management device installed at the side of the manager who manages the sales of the goods via the communication network;
a goods information processing part for processing the goods information received by said goods information receiving part in accordance to customers who purchase the goods from the seller; and
a processed information transmitting part for transmitting the processed information processed by said goods information processing part to said sales management device via the communication network.

18. A sales management system in accordance with claim 17, said sales management system furthermore including
customer devices installed at the sides of customers who purchase goods from the sellers, and wherein
each of said customer devices comprising:
a customer request transmitting part for transmitting requests for disclosure of goods information via a communication network to the sales management device installed at the side of the manager who manages the sales of the goods; and
a reply receiving part for receiving the goods information relevant to the customer as the reply to an abovementioned request for disclosure from said sales management device via said communication network.
